(19) United States
(12) Patent Application Publication
(10) Pub. No.: US 2023/0184342 A1
(43) Pub. Date: Jun. 15, 2023

(54) WAY VALVE

(71) Applicant: Festo SE & Co. KG, Esslingen (DE)

(72) Inventors: Jakob Brenner, Esslingen (DE); Martin Trautwein, Lichtenwald (DE); Nedeljko Alempijevic, Ostfildern (DE)

(21) Appl. No.: 18/075,522

(22) Filed: Dec. 6, 2022

(30) Foreign Application Priority Data
Dec. 9, 2021 (DE) 10 2021 214 056.4

(51) Int. Cl. F16K 11/07; F16K 27/04

(52) U.S. Cl. CPC F16K 11/0712; F16K 27/041

(57) ABSTRACT

A way valve (1) with a 5/2 way valve function has a valve member (13) moveable between two switching positions in a valve member accommodation space (8). The valve member (13) has a valve disk (49) arranged in an inlet section (24) of the valve member accommodation space (8) connected to a feed channel (36), the valve disk having an axially oriented annular valve member sealing surface (56) and being located opposite an annular body sealing surface (54) formed on the valve body (3). So as to close a fluid connection between the inlet section (24) and an attached outlet section (25, 26) of the valve member accommodation space (8) connected to a working channel (37, 38), the valve disk (49) is located with its valve member sealing surface (56) on the opposite body sealing surface (54). Either the body sealing surface (54) or preferably the valve member sealing surface (56) is formed on a collar-like, axially raised sealing edge (57), which has a non-circular, elongated shape, whereby the way valve (1) possesses a high power density.

### BACKGROUND OF THE INVENTION

The invention relates to a way valve with a 5/2 way valve function,
with a valve body, in which a valve member accommodation space, extending along a longitudinal axis of the valve body is formed, in which a valve member, axially moveable between a first and a second switching position is arranged,
wherein the valve member accommodation space has, communicating with a feed channel, an inlet section to which a first outlet section axially communicating on one side with a first working channel and a second outlet section communicating on the other side with a second working channel is connected,
wherein a first inner transition section of the valve member accommodation space is formed between the inlet section and the first outlet section and a second inner transition section of the valve member accommodation space is formed between the inlet section and the second outlet section,
wherein the valve member together with the valve body defines a first inner control structure in the region of the first inner transition section and a second inner control structure in the region of the second inner transition section,
wherein in the first switching position of the valve member, the first inner control structure adopts a closed condition and at the same time the second inner control structure adopts an open condition and wherein in the second switching position of the valve member, the second inner control structure adopts an open condition and at the same time, the first inner control structure adopts an open condition and at the same time, the second inner control structure adopts a closed condition, wherein in the closed condition, the respective assigned transition section is closed so as to prevent a passage of fluid and in the open condition, the respective assigned transition section is open to allow a passage of fluid,
wherein the two inner control structures are designed as poppet valve structures, which respectively have an annular axial body sealing surface formed with framing of the assigned inner transition section on the valve body and facing the inlet section and an annular axial valve member sealing surface axially formed opposite a valve disk of the valve member arranged in the inlet section, fitting close to the axial body sealing surface in the closed condition and lifted off the axial body sealing surface in the open condition, wherein the axial body sealing surface or the axial valve member sealing surface is formed by the front surface of a collar-like annular sealing edge designed to be axially raised.

A way valve of this type known from DE 25 53 250 C3 contains a valve member switchable between two switching positions in a valve member accommodation space of a valve body, which, together with the valve body, defines four control structures, wherein there are two outer control structures axially distanced from each other and furthermore two inner control structures arranged between the two outer control structures. Each of the control structures can adopt a closed condition or an open condition according to the switching position of the valve member, wherein in the open condition, a fluid transfer is possible between two adjacent accommodation space sections of the valve member accommodation space, and is prevented in the closed condition. A centred accommodation space section defines an inlet section, which communicates with a feed channel supplying a fluid pressure medium. Two accommodation space sections flanking the inlet section respectively represent an outlet section, which communicates with a working channel, to which a fluid-operated drive to be operated can be connected. Depending on switching position, the inlet section is connected to one of the two outlet sections to supply fluid, while at the same time, the respective other outlet section is connected to an adjacent further accommodation space section, which involves a vent section communicating with a pressure sink. All control structures are formed as poppet valve structures, which respectively have an annular axial body sealing surface formed on the valve body and an annular axial valve member sealing surface formed opposite the valve member. Each body sealing surface frames a transition section of the valve member accommodation space arranged between two axially adjacent accommodation space sections. The axial body sealing surfaces belonging to the two inner control structures face the inlet section, in which a valve disk of the valve member is located, on which an axial valve member sealing surface is formed for each inner control structure. The axial body sealing surface is formed by the front surface of a circular sealing edge of the valve body, which is designed to be axially raised collar-like and fits close to the one axial valve member sealing surface in the closed condition. The resulting circular sealing contact region frames a circular cross-sectional area of the valve member accommodation space, which is significant for a closing force in the closed condition, with which closing force the valve disk presses against the assigned axial body sealing surface due to the fluid pressure dominant in the inlet section. The circular surface framed by the sealing edge also significantly determines the fluid through-flow in the respective open condition.

A way valve of similar structure is disclosed in DE 28 32 967 C2, wherein this way valve also exclusively possesses control structures formed as poppet valve structures.

DE 10 2018 204 361 B3 discloses a 5/2 way valve, which is designed as a pure slide valve and which possesses four control structures, which are made as slide valve structures, radially sealing in the closed condition.

### SUMMARY OF THE INVENTION

The invention is based on the aim of adopting measures enabling a compact 5/2 way valve that guarantees sure closing conditions at high flow rates.

In order to achieve this aim, it is envisaged, in conjunction with the characteristics mentioned at the start, that the annular sealing edge of both poppet valve structures possesses a non-circular, elongated shape with two narrow sides and two long sides, wherein the annular sealing edge respectively has a bow-shaped sealing edge section in the region of its two narrow sides.

The way valve according to the invention contains two inner control structures, through which a respective fluid connection can be controlled between the inlet section and one of the two outlet sections of the valve member accommodation space. Both inner control structures are designed as poppet valve structures with axial sealing action in the closed condition. In the region of the transition section of the valve member accommodation space assigned to it, each poppet valve structure has an annular axial body sealing surface facing the inlet section and a likewise annular axial valve member sealing surface formed with respect to same, opposite the valve disk arranged in the inlet section. In the closed condition, the body sealing surface and the valve member sealing surface fit axially close to each other while forming an annular sealing contact region. One of the sealing surfaces is formed by the front surface of a collar-like sealing edge designed to be axially raised, which does not have a circular form, but possesses a non-circular and therefore elongated shape, so that it has two narrow sides likewise diametrically opposite with respect to the longitudinal axis of the valve body and likewise two long sides diametrically opposite with respect to the longitudinal axis of the valve body and extending respectively between the two narrow sides. In the region of the two narrow sides, the annular sealing edge respectively has a bow-shaped sealing edge section, curved with a bow-shaped progression, whose convex side points outwards with respect to the longitudinal axis of the valve body. On the basis of this configuration, in the closed condition of each poppet valve structure, an annular sealing contact region is obtained, which matches the progression of the non-circular, elongated sealing edge. The non-circular elongated surface enclosed by this sealing edge can be made relatively large, even with a small structural width of the way valve, which allows high flow-through rates and also allows high fluidic closing forces in the closed condition. Sure closing conditions can thus be guaranteed. For example, the way valve can be embodied as an impulse valve, in which the fluid pressure dominant in the inlet section in conjunction with the non-circular elongated sealing edge generates a high compression force, through which the valve member is securely retained respectively in both switching positions. This and the potential high flow-through with compact dimensions allow a way valve with high power density to be implemented.

Advantageous further developments of the invention emerge from the subclaims.

The non-circular elongated sealing edges of the two poppet valve structures are respectively expediently formed straight or linear in the region of their two long sides and there respectively possess a linear sealing edge section, which merges at the end respectively with one of the two bow-shaped sealing edge sections in the region of the narrow sides. The bow-shaped sealing edge sections are in particular semi-circular in shape. With such a design, the surface framed by the sealing edge and closed in the closed condition, which hereinafter is also designated closing surface, can be very narrow and yet very large because of greater length.

Alternatively, the annular sealing edge could also be for example oval in shape and thereby elliptical in particular.

The annular sealing edges can optionally be formed on the valve body or on the valve disk. A design of the annular sealing edge on the valve disk is preferred because the manufacturing is affordable.

The annular seeing edges are preferably arranged in the region of the radial outer circumferential surface of the valve disk, so that they virtually define the outer contour of the valve disk. In other words, the radial outer contour of the valve disk then matches the non-circular progression of the annular sealing edges.

The two annular sealing edges are preferably located on axial front surfaces, axially turned away from each other, of the same valve disk of the valve member. Depending on the switching position of the valve member, the valve disk fits close to one or the other of the annular sealing edges on the axially opposite body sealing surface.

The annular sealing edges of the two poppet valve structures preferably consist of a material with rubber-elastic properties. For example, they can be made of an elastomer material. It is advantageous in this connection for the entire valve disk to consist of a material with rubber-elastic properties, wherein the annular sealing edges are an integral component part of the valve disk

The body sealing surfaces can be made very affordably when manufacturing the valve body, when they extend respectively in a plane orthogonal to the longitudinal axis of the valve body. The valve body is expediently an injection moulded part consisting of a plastic material, but can also readily be made of metal and in particular an aluminium material.

The two inner transition sections of the valve member accommodation space connected to the inlet section of the valve member accommodation space, at least in an orifice region on the inlet side facing the inlet section, have a non-circular, elongated cross section. The rotational angle orientation of this cross section with respect to the longitudinal axis of the valve body preferably matches that of the respectively assigned annular sealing edge. In other words, the orientation is chosen such that the longitudinal axes of the elongated contoured sealing edge and of the elongated cross section of the orifice region extending orthogonal to the longitudinal axis of the valve body coincide.

The two inner transition sections can have a non-circular elongated cross section over their entire length. However, it is also possible to provide a cylindrical elongated section with a circular cross section after the elongated orifice region in the cross section. However, in principle, the two inner transition sections can also have a circular cross section over their entire length.

The surface framed by the annular sealing edge of a respective poppet valve structure, which was designated above as closing surface, is preferably larger than an ultralarge cross section surface of the assigned inner transition section of the valve member accommodation space.

The valve body preferably has a vertical axis extending in a vertical direction, orthogonal to the longitudinal axis, and a transverse axis extending in a transverse direction, orthogonal both to the longitudinal axis and to the vertical axis. The feed channel and the two working channels are preferably formed in the valve body such that they respectively discharge with an outer channel orifice at a base surface of the valve body pointing downwards in the vertical direction.

The annular sealing edges of the two poppet valve structures are oriented in this connection in particular so that their two narrow sides in the vertical direction and their two long sides in the transverse direction of the valve body are located opposite each other. This way, a way valve can be achieved with a particularly small width in the transverse direction.

In order to achieve the 5/2 way valve function aim, it is expedient for a first vent section of the valve member accommodation space communicating with a first vent channel and a second vent section communicating with a second vent channel of the valve member accommodation space to be connected to the first outlet section on the side opposite the inlet section. A first outer transition section of the valve member accommodation space extends between the first outlet section and the first vent section and a second outer transition section of the valve member accommodation space extends between the second outlet section and the second vent section. The valve member in conjunction with the valve body forms a first outer control structure in the region of the first outer transition section and a second outer control structure in the region of the second outer transition section. Each of these two outer control structures can adopt a closed condition or alternatively an open condition, depending on the switching position of the valve member. In the closed condition, the respective assigned outer transition section is closed so as to prevent a passage of fluid and is open in the open condition so as to allow a passage of fluid. In the first switching position of the valve member, the first inner control structure and the second outer control structure adopt a closed condition, while at the same time, the second inner control structure and the first outer control structure adopt an open condition. In the second switching position of the valve member, the first inner control structure and the second outer control structure adopt an open condition, while at the same time, the second inner control structure and the first outer control structure adopt a closed condition.

The two outer control structures can also be formed as poppet valve structures matching the two inner control structures with axial sealing action in the closed condition. However, it is considered to be more advantageous if the two outer control structures are formed as slide valve structures with radial sealing action in the closed condition. Each of these slide valve structures has a radial body sealing surface formed with framing of the assigned outer transition section on the valve body radially pointing inwards and of the type of the inner circumferential surface of a hollow cylinder and an annular radial valve member sealing surface radially pointing outwards arranged on an outer control section of the valve member. In the closed condition of the respective slide valve structure, its outer control section dips into the assigned outer transition section of the valve member accommodation space and fits with its radial valve member sealing surface close to the radial body sealing surface. In the open condition of the respective slide valve structure, its outer control section adopts a position outside the outer transition section inside the assigned vent section of the valve member accommodation space, so that the radial valve member sealing surface is distanced from the radial body sealing surface and the outer transition section of the valve member accommodation space is freed for a passage of fluid.

In principle, the two slide valve structures can be contoured as non-circular, similar to the poppet valve structures, but are preferably contoured as circular.

In the closed condition of a respective slide valve structure, an annular sealing contact region is formed between the radial body sealing surface and the radial valve member sealing surface fitting close thereto, which involves in particular a circular sealing contact region. The surface framed by this sealing contact region is preferably smaller than a surface already designated further above as closing surface, which is framed by an annular sealing contact region between the axial body sealing surface and its axial valve member sealing surface of a respective poppet valve structure axially fitting close to it in the closed condition. This way, a balance of fluidic forces can be achieved, which ensures that the valve member adopts a stable position in each of its two switching positions, until an additional applied switchover force causes a change of switching position.

The valve member preferably has an axially extending valve member basic body to which the valve disk is fixed as a separate component. The valve member basic body can be formed as one piece or multi-piece. The valve disk involves in particular an annular disk-shaped element consisting of a rubber-elastic material.

The radial valve member sealing surfaces of the slide valve structures are in particular formed on O ring seals, which are fixed to the valve member basic body as separate components.

The way valve can in principle be a directly operated valve, wherein operation is for example pneumatic or electromagnetic. However, it is preferably a pre-controlled way valve, which has an electrically operable pre-controlling valve device for switching the valve member between its two possible switching positions. It is preferably a pre-controlled bistable way valve, although a monostable version is also readily possible.

### BRIEF DESCRIPTION OF THE DRAWINGS

The invention is described in more detail below on the basis of the attached drawing. This shows:

FIG. 1 a preferred embodiment of the way valve according to the invention in longitudinal section along section line I-I of FIGS. 2, 4 and 5, wherein a framed section in the region of the valve disk is illustrated separately, also magnified once more,

FIG. 2 a further longitudinal section of the way valve along section line II-II of FIGS. 1, 4 and 5,

FIG. 3 a bottom view of the way valve with a direction of view along arrow III of FIG. 1,

FIG. 4 a cross section of the way valve along section line IV-IV of FIGS. 1 and 2, and

FIG. 5 a further cross section of the way valve along section V-V of FIGS. 1 and 2.

### DETAILED DESCRIPTION

The drawing illustrates a way valve having a 5/2 way function, which can also be designated 5/2 way valve.

The way valve 1 is preferably of a pre-controlled design. In this connection, it is equipped with an electrically operable pre-controlling device 2, only shown diagrammatically dotdashed in the drawing.

The way valve 1 possesses a valve body 3 with a longitudinal axis 4, whose axial direction may be designated longitudinal axis 4a.

The valve body 3 further has a vertical axis 5 extending in a vertical direction 5a orthogonal to the longitudinal axis 4 and a transverse axis 6 extending in a transverse direction 6a, orthogonal both to the longitudinal axis 4 and to the vertical axis 5.

On an underside pointing downwards in the vertical direction 5a the valve body 3 has a base surface 7, with which it can be mounted ahead for operating same on a valve support, not further illustrated.

A valve member accommodation space 8 extending in the longitudinal direction 4a is formed inside the valve body 3. The valve member accommodation space 8 is arranged coaxially to the longitudinal axis 4. The valve member accommodation space 8 is radially delimited externally by a peripheral limiting surface 12 formed on the valve body 3.

A valve member 13 extends coaxially in the valve member accommodation space 8. Within an axial switching movement 14 illustrated by a double arrow, the valve member 13 can be switched between two switching positions, which are a first switching position visible on the drawing and a second switching position axially displaced with respect to same.

The two switching positions are end positions of the valve member 13, axially opposite each other, which are mechanically defined in that the valve member 13 respectively runs on one of two axially oriented stop surfaces 15 of the valve body 3.

The switching force required to produce the switching movement 14 can be generated for example by means of the pre-controlling valve device 2. The pre-controlling valve device 2 has for example two, only diagrammatically illustrated, electrically operable pre-controlling valves 2a respectively with a 3/2 way valve function.

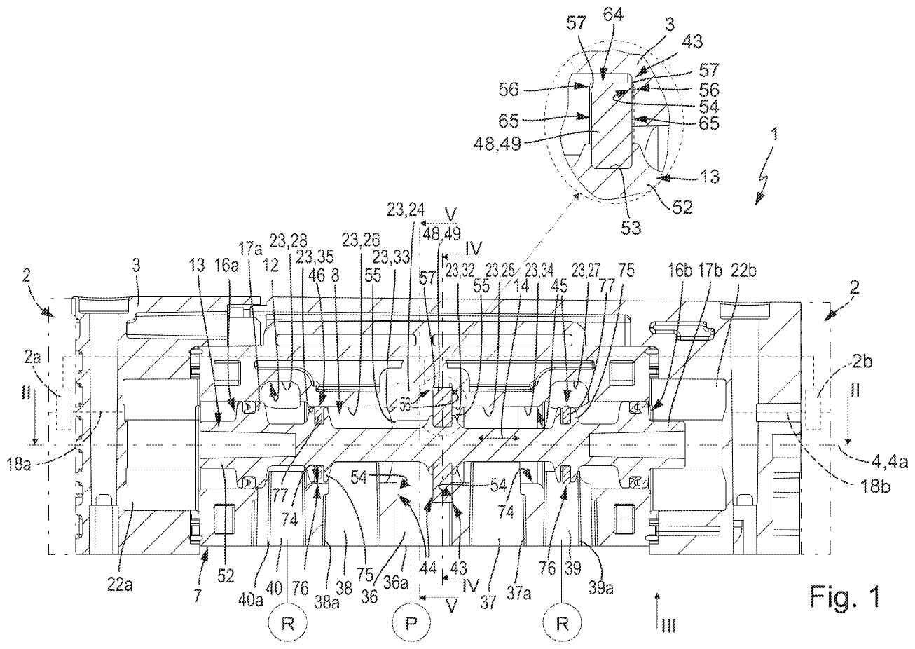

The valve member 13 has two drive surfaces 16, axially turned away from each other, which are respectively formed for example on one of two end sections 17a, 17b of the valve member 13 opposite each other and which can be pressurised with a pre-controlling fluid providing the switching force controlled by means of the respective assigned pre-controlling valve 2a, 2b. A fluid pressurisation of the one first drive surface 16a pointing left in FIG. 1 causes a switching movement 14 of the valve member 13 to the illustrated first switching position, while a fluid pressurisation of the other, second drive surface 16b pointing right in FIG. 1 produces a switching movement 14 of the valve member 13 to a second switching position displaced to the left with respect to the valve body 3.

The delivery and removal of the pre-controlling fluid required for this controlled fluid pressurisation, which in particular is compressed air, is done through a pre-controlling working channel 18a, 18b, illustrated dotdashed, which discharges into one of two drive chambers 22a, 22b, which are formed by the two axial end sections, opposite each other and delimited respectively by one of the two drive surfaces 16a, 16b, of the valve member accommodation space 8.

The valve member accommodation space 8 between the two working chambers 22a, 22b is divided into a plurality of axially successive accommodation space sections 23. One of these accommodation space sections 23 is an inlet section 24, which communicates with a feed channel 36 pushing through the valve body 3, the feed channel preferably discharging at the base surface 7 with an outer channel orifice 36a. When the way valve 1 is operating, the feed channel 36 is connected via the outer channel orifice 36a to an outside pressure source P, which supplies a fluidic pressure medium to be distributed by the way valve 1, which in particular is compressed air.

On the one axial side of the inlet section 24, connected in the following order, there are: a first inner transition section 32, a first outlet section 25, a first outer transition section 34 and a first vent section 27 of the accommodation space sections 23. On the axially opposite side, after the inlet section 24 in the following order, as further accommodation space sections 23, there are: a second inner transition section 33, a second outlet section 26, a second outer transition section 35 and a second vent section 28.

A first working channel 37 discharges into the first outlet section 25, the channel discharging on the other hand, like the feed channel 36, via an outer channel orifice 37a to the base surface 7. In a corresponding manner, a second working channel 38 discharges into the second outlet section 26, the channel discharging in turn via an outer channel orifice 38a to the base surface 7.

And finally, a first vent channel 39 discharges into the first vent section 27 and a second vent channel 40 discharges into the second vent section 28, wherein these two vent channels 39, 40 also discharge via an outer channel orifice 39a, 40a to the base surface 7.

While the two vent channels 39, 40 communicate, when the way valve 1 is operating, with a pressure sink R, which is in particular the atmosphere, the two working channels 37, 38 are designed to connect with a dual action fluid-operated drive, not further illustrated, in particular a linear drive, and for example a pneumatic cylinder.

In the operation-ready condition, the way valve 1 is expediently mounted with the base surface 7 on the aforementioned valve support, in which valve support channels communicating with the abovementioned valve channels 36-40 are formed, the further connection measures being provided on the valve support channels.

The first outlet section 25 is connected, via the first inner transition section 32, to the inlet section 24 and via the first outer transition section 34, to the first vent section 27. The second outlet section 26 is furthermore connected, via the second inner transition section 33, to the inlet section 24 and via the second outer transition section 35 to the second vent section 28.

The valve member 13 defines, in conjunction with the valve body 3, a first inner control structure 43 in the region of the first inner transition section 32, a first outer control structure 45 in the region of the first outer transition section 34, a second inner control structure 44 in the region of the second transition section 33 and a second outer control structure 46 in the region of the second outer transition section 35.

The two inner control structures 43, 44 are designed as poppet valve structures with axial sealing function, and are also designated hereinafter, using the same reference signs, first and second poppet valve structures 43, 44.

The two outer control structures 45, 46 can in principle also be embodied as poppet valve structures, but are preferably designed in accordance with the illustrated embodiment example as slide valve structures with radial sealing function and are therefore also designated hereinafter, using the same reference signs, first and second outer slide valve structures 45, 46.

The valve member 13 has an inner control section 48 formed by a valve disk 49, arranged, irrespective of the switching position, inside the inlet section 24. The valve disk 49 is preferably disk-shaped, wherein the disk plane extends perpendicular to the longitudinal axis 4. For example, the valve disk 49 is designed in an annular disk shape and is mounted coaxially on a valve member basic body 52, separate with respect to same, extending in the longitudinal direction 4a. The valve member basic body 52 has for example in the region of its radial outer circumference an annular retaining groove 53, in which the valve disk 49 is fixed in the region of its radial inner circumference. The valve disk 49 preferably consists of a material with rubber-elastic properties, in particular a thermoplastic elastomer material. The valve disk 49 protrudes around the longitudinal axis 4 radially above the valve member basic body 52, which has a rigid structure and consists for example of a plastic material or a metal.

Each of the two inner control structures 43, 44 has an annular axial body sealing surface 54 formed on the valve body 3 and extending around the longitudinal axis. Both body sealing surfaces 54 expediently extend in a plane orthogonal to the longitudinal axis 4.

Both body sealing surfaces 54 face the inlet section 24, wherein they respectively frame an orifice region 55, with which a respective inner transition section 32, 33 discharges into the inlet section 24. The two body sealing surfaces 54 are distanced from each other and at the same axially face each other.

One of two axial annular valve member sealing surfaces 56 formed on the valve disk 49, which respectively face one of the body sealing surfaces 54 furthermore belongs to each inner control structure 43, 44. Each of these two valve member sealing surfaces 56 is formed by a front surface of an annular sealing edge 57, axially pointing away from the valve disk 49, the sealing edge designed to be axially raised collar-like, so that it protrudes axially with respect to the radially adjacent sections of the valve disk 49 in the direction of the opposite body sealing surface 54.

Because of the fact that the entire valve disk 49 has rubber-elastic properties, the sealing edge 57 is also accordingly designed to be rubber-elastically malleable.

When the valve member 13 is in the illustrated first switching position, the first inner control structure 43 adopts a closed condition and at the same time, the second inner control structure 44 adopts an open condition. These conditions are interchanged in the second switching position of the valve member 13.

The sealing edge 57 of the inner control structure 43 or 44 currently in the closed condition fits axially close with sealing to the body sealing surface 54 with its valve member sealing surface 56 and thereby closes the assigned inner transition section 32 or 33. At the same time, the sealing edge 57 of the other inner control structure 44, 43 situated in the open position is thereby lifted from the body sealing surface 54 facing it, so that a fluid connection is enabled between the assigned inner transition section 33 or 32 and the inlet section 24.

An inner transition section 32 or 33 currently enabled allows a fluid transfer from the inlet section 24 to the assigned first or second outlet section 25, 26 so as to pressurise the connected fluid-operated drive with pressure medium. At the same time, the respective other outlet section 26 or 25 is cut off, impermeably to fluids, from the inlet section 24.

Like the inner control structures 43, 44, the two outer control structures 45, 46 can be alternately moved to a closed condition and an open condition by switching the valve member 13. In the first switching position of the valve member 13, in addition to the first inner control structure 43, the second outer control structure 46 also adopts a closed condition, while at the same time, in addition to the second inner control structure 44, the first outer control structure 45 adopts an open condition. In the second switching position of the valve member 13, in addition to the first inner control structure 43, the second outer control structure 46 adopts an open condition, while at the same time, in addition to the second inner control structure 44, the first outer control structure 45 adopts a closed condition. The open condition manifests itself in a release of the respective assigned outer transition sections 34, 35 so as to enable a fluid transfer between the first or second outlet section 25, 26 and the first or second vent section 27, 28, respectively adjacent with respect to same. In the closed condition of an outer control structure 45, 46, the assigned outer transition section 34, 35 is closed and consequently a fluid transfer is prevented between the assigned first or second outlet section 25, 26 and the first or second vent section 27, 28 adjacent with respect to same.

All things considered, the effect of this control configuration is that in the two switching positions of the valve member 13, the respective one outlet section 25 or 26 is fluid-connected to the inlet section 24 and at the same separated from the adjacent vent section 27 or 28 while at the same time, the respective other outlet section 26, 25 is separated from the inlet section 24 and is fluid-connected to the adjacent vent section 28, 27.

This way, the working chambers connected to the two working channels 37, 38 of a drive to be activated are inversely pressurised with pressure medium or vented alternately, so as to cause a working movement of a drive element of the drive.

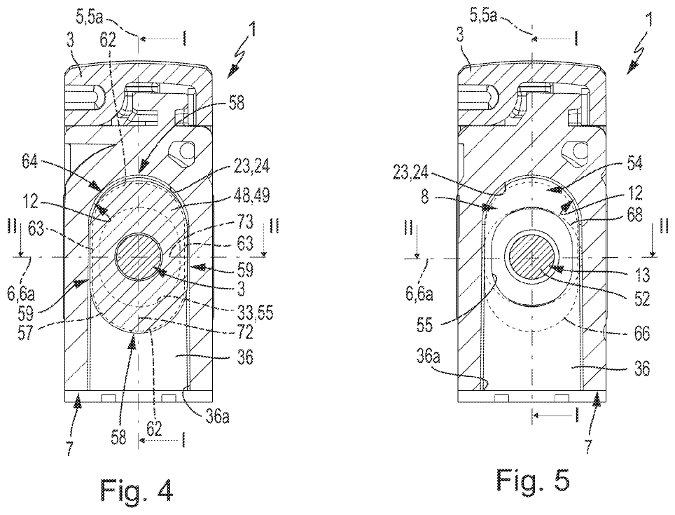

A particularity of the two inner poppet valve structures 43, 44 consists in that their respective annular sealing edge 57 has a non-circular, elongated shape. This is easy to see above all in FIG. 4. This design means that the sealing edge 57 has two narrow sides 58 diametrically opposite with respect to the longitudinal axis 4 and two long sides 59 diametrically opposite with respect to the longitudinal axis 4, which extend between the two narrow sides 58.

In the region of each narrow side 58, the annular sealing edge 57 has a bow-shaped sealing edge section 62 with a convexly curved outer contour on the outer side turned away from the longitudinal axis 4 and a convexly curved inner surface on the inner side facing the longitudinal axis 4.

Each of the two ends of the two bow-shaped sealing edge sections 62 is connected to an opposite end of the other bow-shaped sealing edge section 62, preferably by means of a linear sealing edge section 63, so that the annular sealing edge sections 57 respectively have a straight section in the region of their two long sides 59. The two bow-shaped sealing edge sections 62 are preferably semi-circular in shape, so that they extend over a bow angle of 180°, which is advantageous in that there is a steady transition to the associated linear sealing edge 63.

In an alternative configuration, the annular sealing edge 57 is also curved in a bow shape in the region of its two long sides 59, wherein the curve radius is however significantly wider than in the bow-shaped sealing edge sections 62 of the narrow sides 58. Such an annular sealing edge can be embodied for example oval or elliptical.

It is advantageous for the annular sealing edges 57 to be located in the region of the radial outer circumferential surface 64 of the valve disk 49, wherein the radial outer contour of the valve disk 49 matches the non-circular progression of the two annular sealing edges 57. This is the case in the illustrated embodiment example. The valve disk 49 here has a cross section shape orthogonal to the longitudinal axis 4, the outer contour of the cross section matching that of the two non-circular, elongated annular sealing edges 57.

The valve disk 49 has for example two axial front surfaces 65, turned away from each other in the longitudinal direction 4a. One of the two annular sealing edges 57 is located on each of these two axial front surfaces 65.

When one of the two inner control structures 43, 44 adopts its closed condition, an annular sealing contact region 66, illustrated dotdashed in FIG. 5, whose progression matches the progression of the assigned sealing edge 57, and which is also designated hereinafter elongated sealing contact region 66 for better differentiation, is produced between the body sealing surface 54 and the valve member sealing surface 56 belonging to the inner control structure 43 or 44 concerned. In the closed condition, the valve disk 49 in the region of the surface enclosed by the elongated sealing contact region 66, surface also designated closing surface further above, is exposed to the pressure difference dominant between the inlet section 24 and the outlet section 25 or 26. Since said outlet section 25, 26 question is vented at the same time to the adjacent vent section 27 or 28, a very large pressure difference occurs, which results in a high compression force, due to which the valve disk 49 is pressed with its annular sealing edge 57, which can also be designated valve seat, against the opposite body sealing surface 54. This results in a high retaining force in the switching position concerned, at the same time with high sealing quality.

This functionality is even further assisted for example in that, in the two outer control structures 45, 46, when adopting the closed condition, an annular sealing contact region 68 exists between the valve member 13 and the valve body 3, which is also hereinafter designated circular sealing contact region 68 for better differentiation and which frames a surface that is smaller than the surface framed by the elongated sealing contact region 66. The effect of this is that the pressure difference between the outlet section 25, 26, currently communicating with the inlet section 24, and the dominant fluid pressure to the adjacent vent section 27 or 28 separated with respect to same acts on a significantly smaller surface than the pressure difference between the inlet section 24 and the other outlet section 25 or 26 separated with respect to same. This produces a high resulting compression force for retaining the valve member 13 in the currently set switching position.

A longitudinal axis 72 extending between the two narrow sides 58 and a transverse axis 73 perpendicular with respect to same, extending between the two long sides 59 can be assigned to the non-circular, elongated shape of the sealing edge 57 of a respective inner structure 43, 44. A preferred orientation of the sealing edge 57, which is implemented in the embodiment example, envisages a parallel position between the longitudinal axis 72 of the sealing edge 57 and the vertical axis 5 of the valve body 3, with at the same time, a parallel position of the transverse axis 73 of the sealing edge 57 and the transverse axis 6 of the valve body 3. The result for example is that the outer channel orifices 36a-40a of the five valve channels 36-40 are located on the longitudinal axis 72 of the sealing edge 57, which allows a particularly narrow structure for the valve body 3.

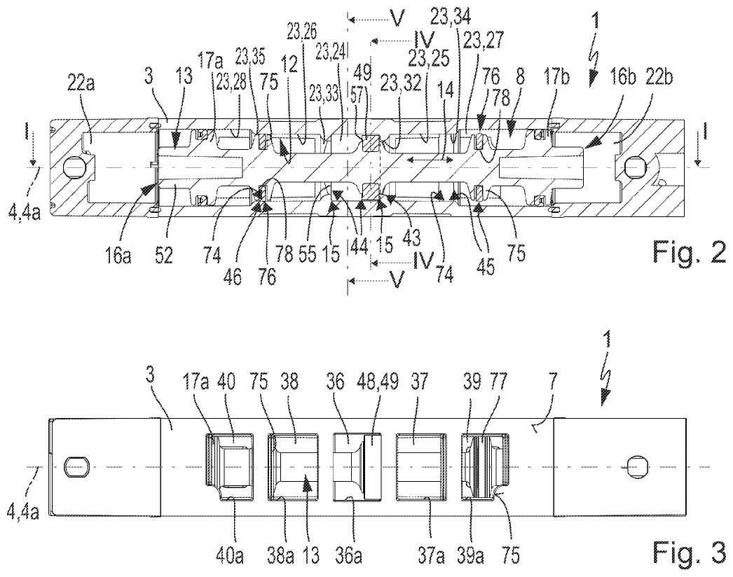

The two inner transition sections 32, 33 of the valve member accommodation space 8 are expediently provided, at least in the orifice region 55, already mentioned further above, with a non-circular, elongated cross section whose longitudinal orientation matches that of the respective assigned annular, elongated sealing edge 57. With this elongated non-circular configuration in conjunction with the special orientation, a relatively large flow cross section of the inner transition section 32, 33 can be achieved. The elongated cross section shape can extend over the entire axial length of the assigned inner transition section 32, 33, although the illustrated embodiment example is different from this. The non-circular orifice region 55 here, as can be seen in particular in FIG. 2, gradually takes on a circular shape, wherein the circular shape preferably matches the cross section of the associated outer transition section 34, 35.

It is advantageous for the surface framed by the annular sealing edge 57 of the respective inner control structure 43, 44 to be larger than an ultralarge cross section surface of the inner transition section 32, 33 closed in the closed condition.

The fluid forces acting in the closing direction on the valve disk 49 in the closed condition can very easily be influenced by the chosen distance of the sealing edge 57 from the longitudinal axis 4, since this distance influences the surface enclosed by the elongated sealing contact region 66.

As already mentioned, the two outer control structures 45, 46 can be embodied in principle, similarly to the inner control structures 43, 44, as poppet valve structures. However, it is considered more advantageous for them to be designed as slide valve structures as in the illustrated embodiment example, and thus to define a first and a second outer slide valve structure 45, 46.

Each of the two outer slide valve structures 45, 46 has a body sealing surface 74, hereinafter designated radial body sealing surface 74, radially pointing inwards, of the type of the inner circumferential surface of the type of a hollow cylinder. Such a radial body sealing surface 74 radially externally delimits each one of the two outer transition sections 34, 35 of the valve member accommodation space 8. The body sealing surfaces 74 are for example also component parts of the peripheral delimiting surface 12 like the axially oriented axial body sealing surfaces of the inner poppet valve structures 43, 44.

In the region of the two outer transition sections 34, 35, the valve member 13 respectively has an outer control section 75 axially distanced from the inner control section 48. Each outer control section 75 belongs to one of the two outer control structures 45, 46 and radially protrudes around the longitudinal axis 4 with respect to axially adjacent sections of the valve member 13. Each outer control section 75 accordingly has the shape of a radially protruding annular band.

Each outer control section 75 possesses an annular valve member sealing surface 76, also designated hereinafter annular radial valve member sealing surface 76, coaxial to the longitudinal axis, radially pointing outwards with respect to the longitudinal axis 4. Each outer slide valve structure 45, 46 accordingly has such a radial valve member sealing surface 76.

When one of the outer poppet valve structures 45, 46 is in the closed condition, its outer control section 75 adopts an axially retracted position in the assigned outer transition section 34 or 35, and, with the radial valve member sealing surface 76, fits close with sealing contact to the radial body sealing surface 74 delimiting the outer transition section 34, 35. This way, the fluid connection between the respective assigned outlet section 25, 26 and the vent section 27, 28 is interrupted. This applies for example to the second outer control structure 46.

In the open condition of an outer control structure 45, 46, its outer control section 75 is located in a position axially outside the assigned first or second outer transition section 34, 35 and thereby inside the assigned first or second vent section 27, 28, so that there is no longer any sealing contact between the radial valve member sealing surface 76 and the radial body sealing surface 74. The assigned first or second outer transition section 34, 35 is accordingly open and the pressure medium can flow through it for a transfer between the assigned outlet section 25 or 26 and the vent section 27 or 28. The first outer control structure 45 has such an open condition in the illustrated embodiment example.

The two outer slide valve structures 45, 46 expediently have circular contours. In this connection, the two outer transition sections 34, 35 respectively have a circular cross section. However, in principle, a non-circular elongated cross section shape similar to the inner transition sections 32, 33 would also be conceivable here.

Each radial valve member sealing surface 76 is expediently formed on an O ring seal 77 possessing rubber-elastic properties, which is fixed as a separate component to the valve member basic body 52 mentioned further above. For example, each O ring seal 77 is held in an annular retaining groove 78 coaxial to the longitudinal axis 4, with the O ring seal radially protruding above the groove with its peripheral section featuring the radial valve member sealing surface 76.

As clearly seen in FIG. 3, the various outer channel orifices 36a-40a are expediently formed consecutively on the base surface 7 in a row in the longitudinal direction 4a.

In an embodiment example, not illustrated, the annular sealing edges 57 with an elongated shape of the two inner control structures 43, 44 are formed on the valve body 3. In this case, the front surface of the sealing edge 57 forms the axial body sealing surface 54. The valve disk 49 In this case has no sealing edge 57 and can be formed as a simple rubber-elastic annular disk with consistently flat front surfaces for forming the two valve member sealing surfaces 56.

The illustrated way valve 1 has a bistable functionality and can be designated an impulse valve. Brief pressurisation of one of the two end drive surfaces 16a, 16b is sufficient to switch the valve member 13 over. In each switching position set thereby, the valve member 13 remains steadily fixed due to the balance of fluid forces applied to it until it experiences a new switchover impulse from the pre-controlling valve device 2. The two axial body sealing surfaces 44 function for example as stop surfaces 15.

Due to the non-circular, elongated sealing edge 57 and the matching non-circular elongated valve seat formed as a result, the pressurised surfaces can be enlarged, so that pressure loading causes the valve to close. At the same time, the vent channels 39, 40 and the O ring seals 77 can be enlarged to maximum size.

In an embodiment, not illustrated, the way valve 1 is of a monostable design. In this case, it possesses only a single drive surface 16a or 16b for fluidic controlling, while a return spring integrated between the valve body 3 and the valve member 13 is operative in the opposite direction.

As can be seen in particular in FIGS. 4 and 5, the feed channel 33, the two working channels 37, 38 and the two vent channels 39, 40—hereinafter also jointly designated valve channels—respectively have a width in the transverse direction, which matches the maximum width of the assigned inlet section 24, outlet section 25, 26 or vent section 27, 28 measured in the same direction. An optimum through-flow can be achieved as a result. The elongated shape of the annular sealing edge 57 nevertheless allows a relatively high wall thickness to be chosen for the valve body 3 in the region of the feed channel 36 so as to guarantee high compression strength and so as to be able easily and reliably to implement the required sealing measures during assembly on the valve support in the region of the base surface 7.

What is claimed is:

1. A way valve with a 5/2 way valve function, the way valve comprising a valve body, in which a valve member accommodation space, extending along a longitudinal axis of the valve body is formed, in which a valve member, axially moveable between a first and a second switching position is arranged,
wherein the valve member accommodation space has, communicating with a feed channel, an inlet section to which a first outlet section axially communicating on one side with a first working channel and a second outlet section communicating on the other side with a second working channel is connected, and
wherein a first inner transition section of the valve member accommodation space is formed between the inlet section and the first outlet section and a second inner transition section of the valve member accommodation space is formed between the inlet section and the second outlet section, and
wherein the valve member together with the valve body defines a first inner control structure in the region of the first inner transition section and a second inner control structure in the region of the second inner transition section, and
wherein, in the first switching position of the valve member, the first inner control structure adopts a closed condition and at the same time the second inner control structure adopts an open condition and wherein in the second switching position of the valve member, the first inner control structure adopts an open condition and at the same time, the second inner control structure adopts an open condition and at the same time, the second inner control structure adopts a closed condition, wherein in the closed condition, the respective assigned transition section is closed so as to prevent a passage of fluid and in the open condition, the respective assigned transition section is open to allow a passage of fluid, and
wherein the two inner control structures are designed as poppet valve structures, which respectively have an annular axial body sealing surface formed with framing of the assigned inner transition section on the valve body and facing the inlet section and an annular axial valve member sealing surface axially formed opposite a valve disk of the valve member arranged in the inlet section, fitting close to the axial body sealing surface in the closed condition and lifted off the axial body sealing surface in the open condition, wherein the axial body sealing surface or the axial valve member sealing surface is formed by the front surface of a collar-like annular sealing edge designed to be axially raised, and
wherein the annular sealing edge of both poppet valve structures possesses a non-circular, elongated shape with two narrow sides and two long sides, wherein the annular sealing edge respectively has a bow-shaped sealing edge section in the region of its two narrow sides.

2. The way valve according to claim 1, wherein the non-circular, annular sealing edges of the two poppet valve structures are respectively formed straight in the region of their two long sides and have a linear sealing edge section, which merges with the two bow-shaped sealing edge sections.

3. The way valve according to claim 1, wherein the bow-shaped sealing edge sections are semi-circular in shape.

4. The way valve according to claim 1, wherein the annular sealing edges of the two poppet valve structures are respectively formed on a valve disk of the valve member arranged in the inlet section.

5. The way valve according to claim 4, wherein the annular sealing edges are arranged in the region of the radial outer circumferential surface of the valve disk, wherein the radial outer contour of the valve disk matches the non-circular progression of the annular sealing edges.

6. The way valve according to claim 4, wherein the two annular sealing edges are formed on axial front surfaces, axially turned away from each other, of one and the same valve disk of the valve member.

7. The way valve according to claim 4, wherein the annular sealing edges of the two poppet valve structures consist of a material with rubber-elastic properties, wherein the entire valve disk consists of a material with rubber-elastic properties

8. The way valve according to claim 4, wherein the body sealing surfaces of the two poppet valve structures are respectively located in a plane orthogonal to the longitudinal axis.

9. The way valve according to claim 1, wherein the two inner transition sections of the valve member accommodation space have, at least in an orifice region on the inlet side facing the inlet section, have a non-circular, elongated cross section whose orientation matches that of the assigned annular, elongated sealing edge.

10. The way valve according to claim 1, wherein the surface framed by the annular sealing edge of a respective poppet valve structure, is larger than an ultralarge cross section surface of the assigned inner transition section of the valve member accommodation space.

11. The way valve according to claim 1, wherein the valve body has a vertical axis extending in a vertical direction, orthogonal to the longitudinal axis, and a transverse axis extending in a transverse direction, orthogonal both to the longitudinal axis and to the vertical axis, wherein the feed channel and the two working channels respectively discharge with an outer channel orifice at a base surface of the valve body pointing downwards in the vertical direction, wherein the annular sealing edges of the two poppet valve structures are oriented so that their two narrow sides in the vertical direction and their two long sides in the transverse direction of the valve body are located opposite each other.

12. The way valve according to claim 1, wherein a first vent section communicating with a first vent channel is connected to the first outlet section on the side opposite the inlet section, and a second vent section communicating with the second vent channel is connected to the second outlet section, and
wherein a first outer transition section is formed between the first outlet section and the first vent section and a second outer transition section of the valve member accommodation space is formed between the second outlet section and the second vent section, and
wherein the valve member in conjunction with the valve body defines a first outer control structure in the region of the first outer transition section and defines a second outer control structure in the region of the second outer transition section, and
wherein, in the first switching position of the valve member, in addition to the first inner control structure, the second outer control structure also adopts a closed condition, and in addition to the second inner control structure, the first outer control structure also adopts an open condition, and
wherein, in the second switching position of the valve member, in addition to the first inner control structure, the second outer control structure also adopts an open condition, and in addition to the second inner control structure, the first outer control structure also adopts a closed condition.

13. The way valve according to claim 12, wherein the two outer control structures are formed as slide valve structures, which respectively have a radial body sealing surface formed with framing of the assigned outer transition section on the valve body radially pointing inwards and of the type of the inner circumferential surface of a hollow cylinder and an annular radial valve member sealing surface radially pointing outwards arranged on an outer control section of the valve member,
wherein, in the closed condition of each slide valve structure, its outer control section dips into the assigned outer transition section of the valve member accommodation space and fits with its radial valve member sealing surface formed thereon close to the radial body sealing surface, and wherein, in the open condition of each slide valve structure, its outer control section adopts a position outside the outer transition section in the assigned vent section of the valve member accommodation space, so that the radial valve member sealing surface is distanced from the radial body sealing surface.

14. The way valve according to claim 13, wherein the two slide valve structures have circular contours.

15. The way valve according to claim 13, wherein an annular sealing contact region between the radial body sealing surface and the radial valve member sealing surface of a respective slide valve structure fitting close to it in the closed condition frame a smaller surface than an annular sealing contact region between the axial body sealing surface and the axial valve member sealing surface of a respective poppet valve structure fitting close to it in the closed condition.

16. The way valve according to claim 1, wherein the valve member has an axially extending valve member basic body to which the valve disk is fixed as a separate component.

17. The way valve according to claim 16, wherein an annular sealing contact region between the radial body sealing surface and the radial valve member sealing surface of a respective slide valve structure fitting close to it in the closed condition frame a smaller surface than an annular sealing contact region between the axial body sealing surface and the axial valve member sealing surface of a respective poppet valve structure fitting close to it in the closed condition, and wherein the radial valve member sealing surfaces of the slide valve structures are formed on O ring seals, which are fixed to the valve member basic body as separate components.

18. The way valve according to claim 1, wherein the way valve is a pre-controlled design equipped with an electrically operable pre-controlling valve device, wherein it is designed as a pre-controlled bistable way valve.
